(19) United States
(12) Patent Application Publication
(10) Pub. No.: US 2004/0046390 A1
(43) Pub. Date: Mar. 11, 2004

(54) Pipe joint and gasket therefor

(76) Inventors: Richard Wolfgang Emil Mosse, London (GB); Jan Rupert Van Der Post, Leicestershire (GB)

Correspondence Address: David H Tannenbaum, Fulbright & Jaworski, Suite 2800, 2200 Ross Avenue, Dallas, TX, 75201, US

(21) Appl. No.: 09/868,584

(22) PCT Filed: Apr. 2, 2001
(86) PCT No.: PCT/GB01/01488

(30) Foreign Application Priority Data
Apr. 3, 2000 (GB) 0008128.1
Oct. 27, 2000 (GB) 0026372.3

(51) Int. Cl. F16L 17/00; F16L 19/00

(52) U.S. Cl. 285/363; 285/367

(57) ABSTRACT

A gasket 1 for a pipe joint 3 between two pipe ends 9, the gasket comprising a sealing portion 5 for producing a seal between the two pipe ends 9 and a gripping portion 7 for gripping at least one of the pipe ends 9 to hold the gasket 1 in position, wherein the sealing portion 5 and the gripping portion 7 are formed integrally. An additional steel wire 31 can be used to pre-stress the gripping portion 7, thereby resulting in a reliable means for mounting the gasket 1 on a pipe end in a self centering manner.

This invention relates to pipe joints, and in particular to an improved gasket for a pipe joint.

Many types of gasket exist, the vast majority of which are manufactured from elastomeric materials. The present invention, however, is directed towards gaskets manufactured from more rigid materials, preferably engineering plastics materials. Examples of these are polyetheretherketone (PEEK), polyethersulfone (PES), TORLON (Trade Mark), ULTEM (Trade Mark), polyamide (such as VESPEL), polyetherimide and polycarbonates.

The present inventors have been involved for some time in the field of hygienic food processing systems and joints for use in such systems, and have developed a number of gaskets and pipe joints such as disclosed in PCT/GB97/01332 and PCT/GB99/03050 for example. However, although these earlier gaskets have been successful, the present invention aims to improve upon them by providing a gasket which is significantly cheaper to manufacture, simple to install and reliable in use.

According to the present invention, there is provided a gasket for a pipe joint between two pipe ends, the pipe ends defining at least one annular recess for receiving a portion of the gasket, wherein the gasket includes a sealing portion for producing a seal between the two pipe ends and locating means for positioning a gasket relative to the pipe ends, wherein the locating means comprise a plurality of protrusions spaced about the gasket for locating in the annular recess of a pipe end to position correctly the gasket relative to the pipe ends.

Preferably the sealing portion and the locating means are formed integrally.

Typical pipe ends, or ferrules, include an annular recess for receiving an annular portion of a gasket for location purposes. Although this arrangement is typically satisfactory and is defined by a British Standard, the present inventors have found that it is actually unnecessary for the gasket to incorporate a complete locating ring to achieve accurate positioning of the gasket. By providing a plurality of protrusions spaced about the gasket for locating in the annular recess of a pipe end, adequate and accurate gasket location can be achieved. Furthermore, a gasket with protrusions for location rather than a complete ring results in a significant saving in gasket material and, perhaps more significantly, a significant reduction in manufacturing time because the gasket cooling time is significantly reduced. Hence, a gasket according to the present invention provides a marked commercial benefit without detracting from the performance of the gasket.

In a particular embodiment, the locating means comprise at least two, preferably three, protrusions defining bearing surfaces for seating in an annular recess in a pipe end. If two protrusions are included, there are preferably situated 120° or so apart around the gasket. More preferably, however, the locating means may include ten or more protrusions spaced in a ring about the gasket face for seating in an annular recess in a pipe end.

The protrusions may be bumps, cones (probably truncated) or stipples, or any other appropriately shaped protrusion for engaging in a recess, or seat, in a pipe end or ferrule. With this in mind, if the protrusions have flat tops, the protrusions can be accommodated in annular recesses to a greater or lesser degree, depending upon the force applied to the pipe joint.

Although the protrusions may extend solely from one side of a gasket, better overall alignment between the pipe ends and the gasket can be achieved by providing protrusions on both sides of the gasket.

As will be appreciated, a gasket according to the present invention is likely to be manufactured from plastics material, probably by injection or compression-moulding. However, thermosetting plastics or elastomers cured by some form of vulcenisation may alternatively be used. Indeed, in theory a metal gasket could be produced, but this would be very expensive. A plastics gasket is much cheaper and provides the characteristics necessary to achieve the desired result of a good seal in an hygienic food processing system or other such application.

The locating means are preferably configured to self-center the gasket about a pipe bore. This feature is extremely beneficial and a marked improvement over known gaskets, as ease of cleaning by pumping a suitable liquid through a line substantially depends on the size of the steps at the joint. Indeed, in the present inventors' application PCT/GB99/03050, a gasket is disclosed which floats freely once it is installed on a pipe end, and cannot therefore be aligned accurately with the pipe bore to produce the best seal arrangement.

As mentioned above, the gasket is preferably manufactured from plastics material, more particularly engineering plastics material, such as polyetheretherketone (PEEK). Plastics materials which do not exhibit creep under the conditions in which the gasket is used are preferred.

The sealing portion preferably comprises a bore surface for alignment parallel with a pipe bore and an adjacent raised seal surface substantially perpendicular to the bore for forming a seal between pipe ends. This type of arrangement, with a seal surface defined by a plateau or nib adjacent the bore surface, has been described in some detail in the current inventors' earlier applications mentioned above. By including such a plateau or nib, a highly improved gasket seal is produced.

According to another aspect of the present invention there is provided a gasket for a pipe joint between two pipe ends, the gasket comprising a sealing portion for producing a seal between the two pipe ends and a gripping portion for gripping at least one of the pipe ends to hold the gasket in position, wherein the sealing portion and the gripping portion are formed integrally.

In such an arrangement, the gripping portion is preferably configured to self-center the gasket about a pipe bore.

Preferably the gripping portion comprises at least two resilient structures defining bearing surfaces for gripping a pipe end. More particularly, the gripping portion may include two (or three) T-shaped resilient structures spaced by approximately 180° (or 120°) about the gasket.

In a particular embodiment, the gripping portion includes four arms spaced about the circumference of the gasket, each arm including a bearing surface for gripping a pipe end. Two T-shaped resilient structures may be provided, each T-shaped structure defining two of the four arms.

In another embodiment, resilient structures having other shapes may be used. For example, three or more structures having a single bearing surface may be appropriate.

A gasket according to the present invention preferably further comprises means for applying a pre-stress to the gripping portion so that the gripping portion applies a greater gripping force during use. With this in mind, it is preferable that the gasket can be positioned adjacent a pipe end and forced onto the pipe end without undue manipulation. Hence, by opening the gripping portion by applying a pre-stress before mounting the gasket on a pipe end, a significant gripping force can be generated and yet the gasket can still be readily mounted on a pipe end. Further, by applying a pre-stress to the gripping portion, the gasket will be held firmly and securely on a pipe end prior to closing of the pipe joint.

As will be appreciated, the force applied by the gripping portion of the gasket is designed to act perpendicularly to the bore of the pipe by virtue of the gripping portion gripping the outside surface of the pipe end or ferrule. Thus, the gasket will not spring free from a pipe end, which could happen if the force applied by the gripping portion were to have a component acting parallel to the bore.

The means for applying a pre-stress preferably comprises at least one member or bar, possibly resilient, held between the sealing portion and the gripping portion of the gasket. The or each bar will hold the arms of the T-shaped resilient structures out from their rest positions, thereby applying the pre-stress.

Lugs are preferably formed as part of the gasket to position and hold accurately the or each bar. With this in mind, the lugs are preferably offset on both sides of the or each bar.

Although the or each bar could be manufactured from any material having the appropriate characteristics, it is envisaged that a metal wire is likely to be used. A stiff metal wire with a degree of resiliency is a possibility. Alternatively, one or more rigid rod may be used.

Preferably the or each bar is manufactured from metal and acts as a compression stop between the pipe ends during use in a pipe joint.

The present invention further provides a pipe joint comprising two pipe ends defined by ferrules, a clamp acting on the ferrules to close the joint and a gasket as claimed herein between the ferrules. By using a gasket as herein claimed, simple installation can be achieved with improved centering of the gasket.

Preferably the gasket includes at least one metal stop against which the ferrules bear to prevent overtightening of the clamp.

The ferrules preferably contact the sealing portion of the gasket before the stop, during clamping, thereby resulting in a sealing pressure being applied to the gasket.

More preferably, the resiliency of the ferrules is utilised to apply a continual pressure between the ferrules and the sealing portion of the gasket following clamping. This can be achieved by defining the various dimensions of the components such that, when the ferrules have been clamped closed against the metal stop of the gasket, a firm pressure is applied to the sealing portion of the gasket by the ferrules whilst the ferrules remain in a stressed but resilient state. Hence, the resiliency of the ferrules will apply a continual force against the sealing portion of the gasket to ensure that the seal remains reliable throughout the lifetime of the pipe joint.

A specific embodiment of the present invention is now described, by way of example only, with reference to the accompanying drawings, in which:—

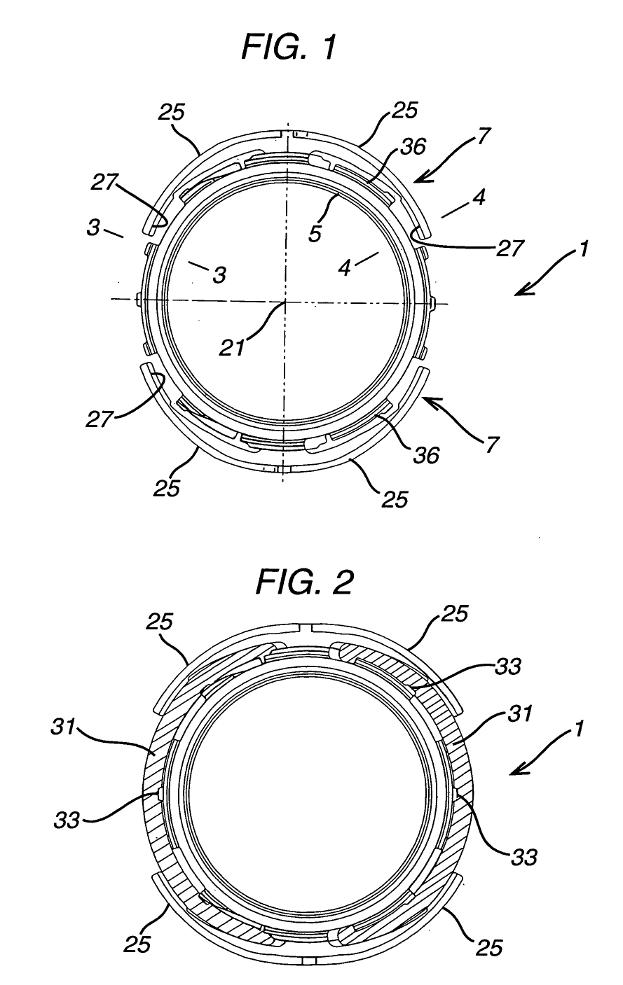

FIG. 1 is a plan view of a gasket according to the present invention;

FIG. 2 is a plan view of a gasket according to the present invention including means for pre-stressing the gasket gripping portion;

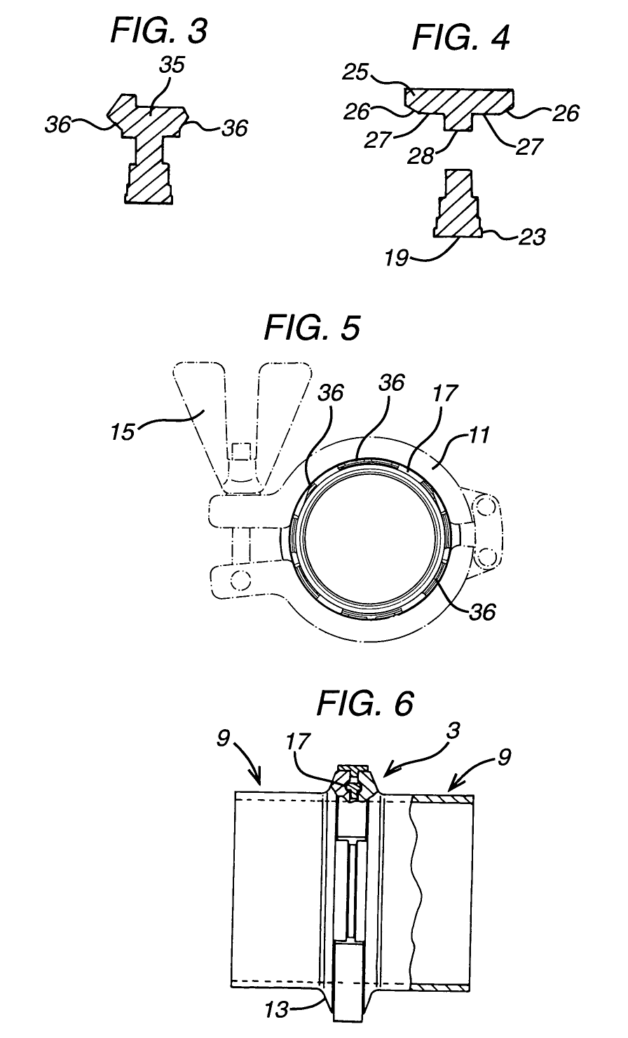

FIG. 3 is a cross section along the line 3-3 in FIG. 1;

FIG. 4 is a cross-section along the line 4-4 in FIG. 1;

FIG. 5 is a cross-sectional axial view through a pipe joint showing a ferrule and clamp;

FIG. 6 is a schematic side sectional view of a pipe joint incorporating a gasket according to the present invention;

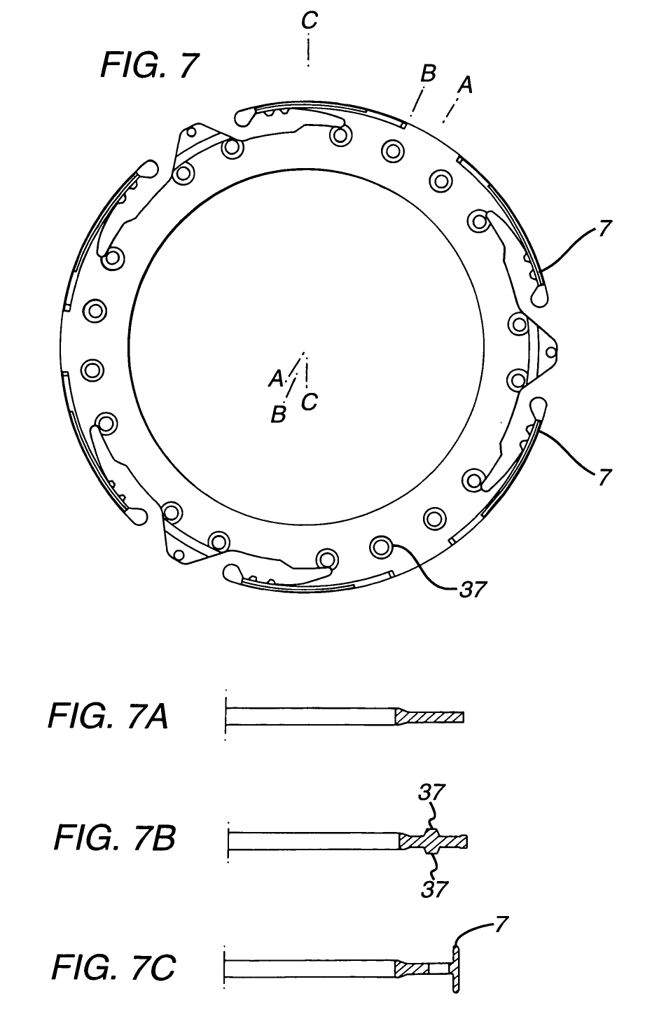

FIG. 7 is a plan view of another embodiment of gasket according to the present invention;

FIGS. 7A, 7B and 7C are cross sections along the lines A, B and C in FIG. 7;

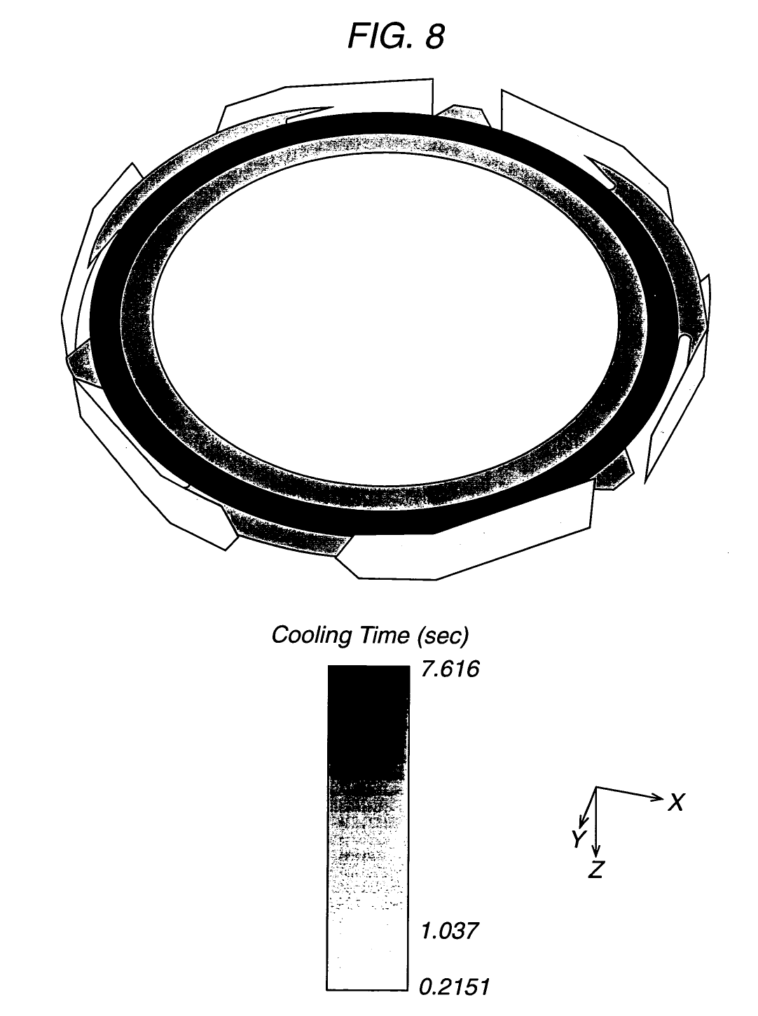

FIG. 8 is a computer generated representation depicting cooling time for a gasket incorporating a complete locating ring; and

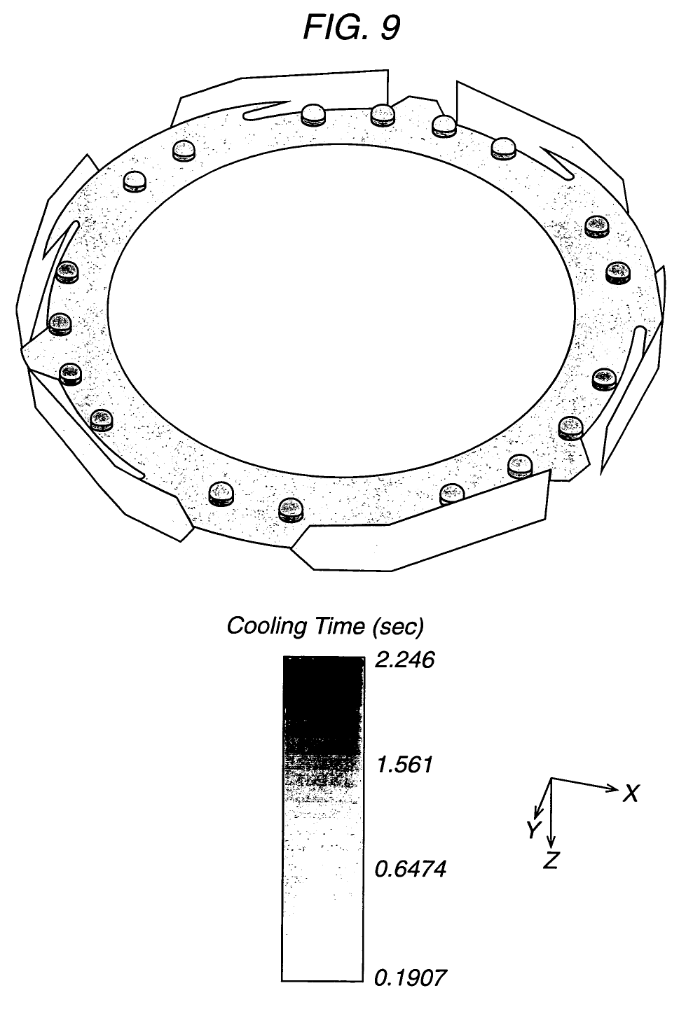

FIG. 9 is a computer generated representation depicting cooling time for a gasket incorporating locating bumps.

With reference to the drawings, a gasket 1 according to the present invention and a pipe joint 3 according to the present invention are shown. The gasket 1, which is manufactured in one piece from engineering plastics material, such as polyetheretherketone (PEEK), comprises an inner sealing portion 5 and an outer gripping portion 7. The gasket 1 is designed for use in the pipe joint 3 between ferrules 9 at pipe ends. The gripping portion 7 of the gasket 1 clips onto one of the ferrules 9 such that the gripping portion 7 physically grips the outside surface of the ferrule 9. A pivoted clamping device 11, acting against tapered outside surfaces 13 of the ferrules 9 is tightened using a threaded wing nut and bolt 15 to cause a seal to be produced between the ferrules 9 and the gasket 1.

The idea of a gasket between two pipe end ferrules tightened by a clamp is, of course, well known. Further, pipe end ferrules typically have a mating surface as shown in FIG. 5, with a concentric circular groove 17 formed therein. The gasket seal is formed immediately adjacent the internal bore of the ferrule 9, as is described in earlier application PCT/GB97/01332, the content of which is hereby incorporated by reference.

Turning now to FIGS. 1 and 4 specifically, the sealing portion 5 is essentially an annular ring defining a bore surface 19 parallel to the axis 21 of the gasket and an adjacent raised surface 23 on either side of the sealing portion perpendicular to the pipe bore for abutting the mating surfaces of the ferrules 9. These raised surfaces 23, or plateaux/nibs, are described in detail in earlier application PCT/GB97/01332 and will not be described any further here.

The gripping portion 7 of the gasket 1 is defined by two T-shaped resilient structures each defining a pair of arms 25 carrying a bearing surface 27 for gripping a pipe ferrule 9 (as shown clearly in FIG. 6). A cross section through an arm 25 can be seen in FIG. 4. By providing a chamfered or lead-in surface 26 on the sides of the arms 25, it is possible to push-fit the gasket 1 onto a pipe end ferrule 9, such that the gasket 1 is retained on the ferrule 9 by virtue of the force supplied by the gripping portion 7. The active region of the bearing surface 27 is, however, flat to ensure that a positive grip is achieved.

By virtue of the inclusion of four arms 25, and hence four bearing surfaces 27 each exerting a force on the outside of a pipe end ferrule 9, during use, and the fact that the force increases as the distance from the center of the pipe bore increases, so a balance is achieved when all the arms 25 are distorted equally. This gives a centering action which assists greatly in alignment of the gasket 1 correctly relative to the axis of the pipe bore.

Turning now to FIGS. 2 and 3 of the drawings, the gasket 1 shown in FIG. 1 has had two steel wires 31 inserted between the sealing portion 5 and the gripping portion 7. The wires 31 are held in position by means of a series of lugs 33, which are offset on both sides of each wire 31. The wires 31 pass under the arms 25 and act to pre-stress these arms prior to installation of the gasket on a pipe end ferrule 9. A central rib 28 of each arm 25 rests on a wire 31, as shown in FIGS. 2 and 4. By adding the steel wires 31, which hold the arms 25 outwardly from their “as moulded” rest positions, the arms 25 are under stress (or pre-stressed) even prior to the bearing surfaces 27 being applied to the outside surfaces of the pipe end ferrules 9. By pre-stressing the arms 25, a small deflection of the arms 25 during installation on a pipe end ferrule 9 will result in a significant increase in the force applied by the bearing surfaces 27 for gripping the ferrule 9. Conversely, if the arms 25 were moulded in a more open position and the wires 31 were not used, the same deflection of the arms would not result in the same amount of force being applied to the ferrule 9, since the arms would not have been pre-stressed.

As will be appreciated, the embodiment shown in FIG. 2 is the preferred embodiment, since a greater gripping force is applied by the bearing surfaces 27 following mounting of the gasket 1 on a pipe end ferrule 9. However, the embodiment shown in FIG. 2 also has a further advantage, as will now be described.

Due to the inclusion of the two steel wires 31, a stop is provided which can be used to prevent over-tightening of the clamp 11, and hence deformation of the ferrules 9, because the mating surfaces of each ferrule 9 will abut the steel wires 31. Excessive compression of the plastics gasket 1 can also thereby be prevented.

As may be appreciated from FIGS. 3 and 4 of the drawings, the lugs 33 and their support structures 35 are situated in alignment with the groove 17 in each mating surface of the ferrules 9, thereby facilitating location of the gasket 1 with respect to the pipe end ferrules 9. Further, although sufficient force acts between the lugs 33 and support structure 35 and the grooves 17 to achieve accurate location and self-centering of the gasket 1, the main pressure applied by the clamp 11 acts primarily through the ferrules 9 and the raised surfaces (or plateaux) of the sealing portions 5. Thus, a reliable seal is provided immediately adjacent the bore of the pipe.

By arranging the relative dimensions of the various components of the pipe joint 3 in an appropriate manner, it is possible to close the pipe joint and apply sealing pressure to the gasket 1 via the raised surfaces 23 of the gasket 1. If, however, the dimensions are selected correctly, further clamping of the pipe joint can be effected until the mating surfaces of the ferrules 9 abut the stop formed by the metal wires 31. Further closing of the pipe joint is thereby prevented, but at this stage the ferrules 9 are in a state of resilience whereby they continue to apply pressure to the sealing surfaces of the gasket throughout the lifetime of the pipe joint. More particularly, the ferrules 9 are in a state of resilience with one part abutting the stop formed by the steel wires 31 and each free annular area adjacent to the groove 17 applying a continual force to the sealing surfaces of the gasket 1. Hence, a continual force is applied throughout the lifetime of the pipe joint, thereby ensuring that a permanent seal is produced. This is a marked improvement over known seals.

To assemble a pipe joint according to the present invention, it is a simple matter to apply a gasket as shown in FIG. 1 or FIG. 2 to one of the pipe end ferrules 9. The second pipe end ferrule 9 can then be brought into mating engagement with the gasket 1 and the clamp 11 can be applied. Tightening of the clamp will cause a reliable seal to be formed between the ferrules 9 and the gasket 1. When undoing the pipe joint, the reverse procedure is utilised. Due to the resilience of the gripping portion 7 and the engineering plastics material of the gasket 1, it is possible to reuse the gasket 1 in another application.

As will be appreciated, although the specific embodiment relates to a pipe joint which uses a pivoted clamping device 11, other clamping devices, such as couplings using threaded nuts or multiple bolts in flanges, could alternatively be used. Further, although the embodiment of FIG. 2 includes two steel wires 31, another embodiment (not shown) could use a single wire member to support all the bearing surfaces in a pre-stressed state. Such a single wire may extend through on arc of more than 270°, preferably 300° or so, passing the various bearing surface supports. If such a wire is used, which will have a diameter greater than the bore of the pipe itself, the wire will not be able to fall into the pipe bore accidentally during installation or dismantling of the joint. A safer arrangement will therefore result.

Turning now to FIG. 7 of the drawings, another gasket 1 according to the present invention is shown. The gasket 1 is similar to that shown in FIG. 1, but where in FIG. 1 a discontinuous rail 36 (comprising the lugs 33 and their support structures 35) is included for seating in an annular recess 17 in a pipe ferrule face (cf. FIG. 6), a series of bumps or truncated cones 37 are included. The profile of these bumps or truncated cones can be seen clearly in the sectional view of FIG. 7B. These bumps 37 are arranged on the circumference of a circle (or ring) centered on the axis of the gasket 1 at a radius corresponding to the radius of the annular recesses or grooves 17 in the pipe end ferrules 9. As a result, when a gasket 1 is positioned in a pipe joint 3, the bumps 37 are seated in the annular recesses 17 to dictate and locate accurately the gasket position with respect to the pipe end ferrules 9. Thus, improved location, and hence sealing, can be achieved.

Although the gasket 1 shown in FIG. 7 includes three gripping portions 7 of the kind previously described, in theory a gasket could take advantage of the present invention irrespective of whether or not gripping portions are included. More particularly, a gasket which simply has a plurality of protrusions or bumps 37 for engaging a recess or recesses in pipe end ferrules 9 could be provided, and would enable a gasket to be accurately aligned with respect to the pipe end ferrules 9. Clearly, however, the gripping portions 7 aid location of the gasket on a pipe end ferrule and assist in accurate alignment of the gasket. The protrusions 37 also assist in this regard.

Turning now to FIGS. 8 and 9, these show computer generated representations of cooling time for a gasket incorporating a complete locating ring 39 (FIG. 8) and a gasket incorporating a plurality of spaced protrusions 37 (FIG. 9) according to the present invention. As can be seen from the Figures, the complete locating ring 39 of FIG. 8 takes a significant amount of time (7.6 seconds) to cool during moulding, whereas the bumps 37 of the gasket shown in FIG. 9 are much quicker to cool. The gasket of FIG. 9 taking approximately 2.2 seconds to cool. Hence, a vast reduction in cooling time during manufacture can be achieved by using a gasket according to the present invention, thereby enabling a much faster manufacturing time to be achieved. Indeed, an improvement of 50% or more in overall manufacturing cycle time has been noted by the present inventors, thereby typically reducing the marginal cost of producing a gasket by between 25-75%. This is clearly significant in large volume manufacturing processes.

A further benefit of a gasket according to the present invention is that there is a considerable material saving to be gained from using bumps 37 rather than a complete locating ring. In the case of a gasket having a diameter of 50 mm, the use of bumps 37 results in a saving of around 1¼ grams of a material on a gasket with a net weight after the saving of about 3¼ grams. This is a saving of 25% on the material consumption where material accounts for almost all the marginal costs of the component apart from the manufacturing cycle.

Overall, the result is a saving of between 33%-50%, on marginal manufacturing costs, which is not insignificant.

Another benefit arising from a gasket according to the present invention is that more uniform cooling and less shrinkage occurs. This significantly reduces the risk and extent of distortion in a moulded gasket. Thus, once again, a gasket according to the present invention is a marked improvement over a prior art gasket in which a complete locating ring is formed on each face of the gasket. Furthermore, as will be appreciated, distortion can be a significant problem in hygienic pipe joints, and even more so when the gasket is manufactured from engineering plastics material such as polyetheretherketone (PEEK).

It will of course be understood that the present invention has been described above purely by way of example, and that modifications of detail can be made within the scope of the invention.

1. A gasket for a pipe joint between two pipe ends, the gasket comprising:
a sealing portion for producing a seal between the two pipe ends and
a gripping portion for gripping at least one of the pipe ends to hold the gasket in position,
characterised in that the sealing portion and the gripping portion are manufactured in one piece from engineering plastics material.

2. A gasket as claimed in claim 1, wherein the gripping portion is configured to self-center the gasket about a pipe bore.

3. A gasket as claimed in claim 1 or claim 2, wherein the gripping portion comprises at least two resilient structures defining bearing surfaces for gripping a pipe end.

4. A gasket as claimed in any one of claims 1 to 3, wherein the gripping portion includes two T-shaped resilient structures.

5. A gasket as claimed in claim 4, wherein the T-shaped resilient structures are spaced by approximately 180° or 120° about the gasket.

6. A gasket as claimed in any one of claims 1 to 5, wherein the gripping portion includes four or six arms spaced about the circumference of the gasket, each arm including a bearing surface for gripping a pipe end.

7. A gasket as claimed in any one of claims 1 to 6, further comprising means for applying a pre-stress to the gripping portion so that the gripping portion applies a greater gripping force during use.

8. A gasket as claimed in claim 7, wherein the means for applying a pre-stress comprises at least one member held between the sealing portion and the gripping portion.

9. A gasket as claimed in claim 8, wherein the or each member is positioned by means of lugs formed as part of the gasket.

10. A gasket as claimed in claim 9, wherein the lugs are offset on both sides of the or each member.

11. A gasket as claimed in any one of claims 8 to 10, wherein the or each member is manufactured from metal and acts as a stop between the pipe ends during use.

12. A gasket as claimed in any one of claims 8 to 11, wherein the or each member is a metal wire.

13. A gasket as claimed in any one of claims 8 to 12, wherein the member extends through an arc of more then 270°.

14. A gasket as claimed in any preceding claim, further comprising:
locating means comprising a plurality of protrusions spaced about the gasket for positioning the gasket relative to the pipe ends.

15. A gasket as claimed in claim 14, wherein the sealing portion and the locating means are formed integrally.

16. A gasket as claimed in claim 14 or claim 15, wherein the locating means are configured to self-center the gasket about a pipe bore.

17. A gasket as claimed in any one of claims 14 to 16, wherein the locating means comprise at least three protrusions defining bearing surfaces for seating in an annular recess in a pipe end.

18. A gasket as claimed in any one of claims 14 to 17, wherein the locating means include ten or more protrusions.

19. A gasket as claimed any one of claims 14 to 18, wherein the protrusions are bumps, truncated cones or stipples.

20. A gasket as claimed in any one of claims 14 to 19, wherein the protrusions have flat tops.

21. A gasket as claimed in any one of claims 14 to 20, wherein the protrusions extend from both sides of the gasket.

22. A gasket as claimed in any one of claims 14 to 21, wherein each protrusion is substantially round in plan.

23. A gasket as claimed in any one of claims 14 to 22, wherein each protrusion is substantially the same.

24. A gasket as claimed in any preceding claim, wherein the engineering plastics material is PEEK or ULTEM.

25. A gasket as claimed in any preceding claim, wherein the sealing portion comprises a bore surface for alignment parallel with a pipe bore and an adjacent raised surface perpendicular to the bore for forming a seal between pipe ends.

26. A pipe joint comprising two pipe ends defined by ferrules, a clamp acting on the ferrules to close the joint and a gasket according to any preceding claim between the ferrules.

27. A pipe joint as claimed in claim 26, wherein each ferrule includes an annular recess for receiving protrusions of the locating means.

28. A pipe joint as claimed in claim 26 or claim 27, wherein the gasket includes a metal stop against which the ferrules bear to prevent overtightening of the clamp.

29. A pipe joint as claimed in claim 28, wherein the ferrules contact the sealing portion of the gasket before the stop, during clamping, thereby resulting in a sealing pressure being applied to the gasket.

30. A pipe joint as claimed in any one of claims 26 to 29, wherein resiliency of the ferrules is utilised to apply a continual pressure between the ferrules and the sealing portion of the gasket following clamping.
